(19) United States
(12) Patent Application Publication
(10) Pub. No.: US 2012/0158561 A1
(43) Pub. Date: Jun. 21, 2012

(54) SYSTEM AND METHOD FOR REAL ESTATE INVESTMENT MANAGEMENT AND ANALYSIS

(75) Inventors: Loretta GANNON, East Meadow, NY (US); Edward SHANE, Berwyn, PA (US); Declan DENEHAN, New York, NY (US); Thomas GALLAGHER, New York, NY (US); Bruce W. GOELZ, Plainview, NY (US)

(73) Assignee: THE BANK OF NEW YORK MELLON, A NEW YORK BANKING CORPORATION, New York, NY (US)

(21) Appl. No.: 13/328,655

(22) Filed: Dec. 16, 2011

Related U.S. Application Data
(60) Provisional application No. 61/424,460, filed on Dec. 17, 2010.

(51) Int. Cl. G06Q 40/06; G06Q 30/04; G06Q 50/16

(52) U.S. Cl. 705/34; 705/36 R; 705/30

(57) ABSTRACT

A computer system and method evaluates reports financial data pertaining to real estate investments via an investor access portal. The investor access portal may be accessed over the Internet. Real estate investors, having a financial investment in each of a plurality of properties, may review accounts payable and accounts receivable data from each of the plurality of properties, managed by a plurality of property managers. Accounts receivable and accounts payable funds may be managed via the investor access portal, so that funds are centrally received and transmitted, and that data about said transmissions and receptions may be maintained and accessed by real estate investors via the investor access portal. The real estate investors may compare the data against other properties, including those managed by the same property manager, those managed by other property managers, or both, so as to reduce operating and utility costs for the properties.

This application claims benefit under 35 U.S.C. 119(e) to U.S. Provisional Application Ser. No. 61/424,460, incorporated herein in its entirety by reference.

### BACKGROUND

This disclosure relates to a computerized system and method for providing comprehensive data management and analysis of real estate investments.

Traditionally, a paradigm has existed wherein real estate investors have relied on property managers to manage the investor's wholly owned or joint venture real estate properties. Under this paradigm, the real estate investor learns after the fact of the status of income and expenditures, and sees the investment purely from an accounts receivable standpoint. For example, the property managers may notify the investor of the receipt of a rental check, or the payment of a utility bill, while the real estate investor is further removed from the financial intricacies of each property. While a fiduciary contract and relationship exists between the property managers and the investor, the control of services and associated decisioning has remained with the property managers. When real estate investors have financed a large number of investment properties, they may utilize a plurality of property managers, depending on the location of the property, the size of the property, or so on. Sometimes property managers may outsource financial transaction services to investment banks, which may manage the transaction, investment, and information services associated with the movement of money associated with their own managed investment property.

Over the last few years, a number of factors have shaken the real estate and financial markets in ways that may increase the desirability of real estate investors maintaining greater control over financial decisions relating to real estate management. Instabilities in the market have started to decrease the value of the investment properties, such that real estate investors are becoming more cost sensitive to expenditures in a portfolio of real estate investment properties. In such an economic climate, it may be desirable for the real estate investor to take a more commanding role in the financial decisions associated with investment properties.

Among other things, the present disclosure provides improved computerized mechanisms to permit real estate investors to manage and analyze the financial aspects of real estate investment properties.

### SUMMARY

This disclosure provides various embodiments and aspects of a system and method for enabling real estate investors to manage and analyze expenditures and returns across a portfolio of investment properties. In one aspect, the portfolio of investment properties may utilize a plurality of property managers. In another aspect, this disclosure provides a system and method for centralizing the flow of money associated with the portfolio of investment properties.

In an embodiment, a computer-implemented method of managing, evaluating and reporting financial information for real estate investment portfolios, includes storing, in a database associated with a memory device, first property information associated with at least one or more first properties managed by a first property manager, and second property information associated with at least one or more second properties managed by a second property manager. The method may also include using a processor to compare the first property information and the second property information. The method may further include outputting for use by a real estate investor, one or more of the first property information, the second property information, and the comparison of the first property information and the second property information. The real estate investor may have a financial interest in each of the managed properties.

In another embodiment, a system for computerized management, evaluation, and reporting of financial information for real estate investment portfolios, includes a management platform comprising an operatively interconnected processor and a memory device. The system also includes a database associated with the memory device and configured to store property information received over a network connection. The property information includes first property information associated with at least one or more first properties managed by a first property manager, and second property information associated with at least one or more second properties managed by a second property manager. The processor is configured to compare the first property information and the second property information, and output for use by a real estate investor, one or more of the first property information, the second property information, and the comparison of the first and second property information. The real estate investor may have a financial interest in each of the managed properties.

In another embodiment, an article of manufacture comprises a tangible, non-transitory computer-readable medium therein. The computer-readable medium contains computer-readable instructions thereon which, when executed by a computer processor, cause the processor to carry out functions related to managing, evaluating and reporting financial information for real estate investment portfolios. The functions include storing, in a database associated with a memory device, first property information associated with at least one or more first properties managed by a first property manager, and second property information associated with at least one or more second properties managed by a second property manager. The functions also include comparing the first property information and the second property information, and outputting for use by a real estate investor, one or more of the first property information, the second property information, and the comparison of the first property information and the second property information. The real estate investor may have a financial interest in each of the managed properties.

In another embodiment, a system for computerized management, evaluation, and reporting of financial information for real estate investment portfolios includes a management platform comprising an operatively interconnected processor and a memory device. The system also includes a database associated with the memory device and configured to store property information received over a network connection. The property information includes first property information associated with at least one or more first properties managed by a first property manager, and second property information associated with at least one or more second properties managed by a second property manager. The first property information comprises first accounts payable or receivable information, and the second property information comprises second accounts payable or receivable information. The first and second accounts payable or receivable information includes bills associated respectively with the one or more first properties or the one or more second properties. The database may be further configured to provide storage for and categorize copies of one or more of deeds, titles, and lease agreements associated with at least the one or more first properties and/or the one or more second properties. The processor is configured to compare the first property information and the second property information. The processor is also configured to perform an audit of said bills to identify potential expenditure savings, electronically present bills to the one or more tenants, and receive an input from a real estate investor and/or the one or more tenants to pay said bills via at least one user interface. The processor is also configured to provide accounting based on a portfolio including the one or more properties and an investment fund associated with the one or more properties. The processor is also configured to output for use by the real estate investor one or more of the first property information, the second property information, the comparison of the first property information and the second property information, a result of said audit, and a result of said accounting. The management platform is operatively coupled to a centralized location comprising one or more of a lockbox, a remote check depositing service, or an electronic payment service, the centralized location configured to receive funds from one or more of the real estate investor and tenants of the first property and/or the second property, associated with one or more of the first properties and one or more of the second properties. The first property information and the second property information each comprise one or more of valuation, fiscal information, location information, property size, tax information, mortgage payments, utility expenses, tenant information, and rental income. The real estate investor may have a financial interest in each of the managed properties.

The system and method of this disclosure further provides various capabilities as discussed more fully in the detailed description below.

### BRIEF DESCRIPTION OF THE DRAWINGS

Embodiments of the disclosure will now be described with reference to the accompanying drawings in which:

FIG. 1 provides a block diagram of an embodiment of a computer-implemented and networked system for real estate management and analysis;

FIG. 2 schematically depicts an associated functional block diagram for an embodiment of the system for real estate management and analysis of FIG. 1;

FIG. 3 provides an illustrative screen shot representing fiscal analysis data that may be provided via a graphical user interface of an embodiment of this disclosure;

FIG. 4 provides illustrative screens that may be provided via a graphical user interface of an embodiment of this disclosure; and

FIG. 5A-B provides an illustrative screen shots representing a location based real estate financial analysis that may be provided via a graphical user interface of an embodiment of this disclosure.

### DETAILED DESCRIPTION

The investment real estate management system and method described herein may be implemented by a system that includes various computer processors and peripheral devices, such as memory devices, databases, and network interfaces, including the Internet.

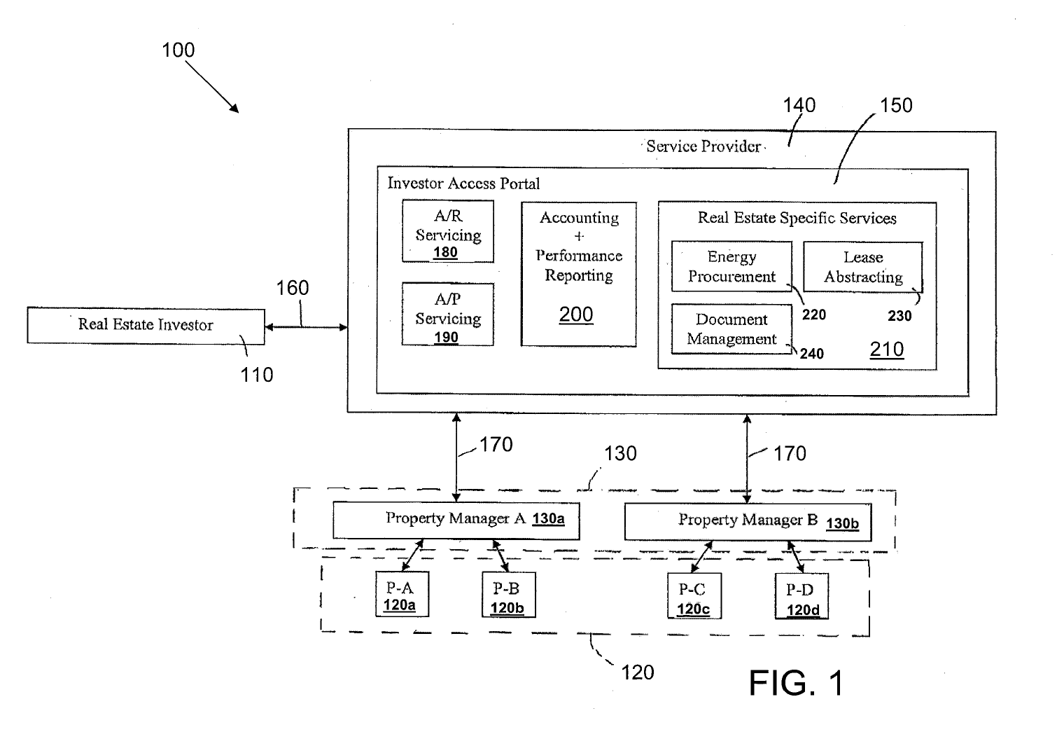

FIG. 1 illustrates a schematic block diagram of real estate management system 100 wherein real estate investor 110 owns or otherwise has a financial interest in a plurality of properties 120. The financial interest may be, for example, partial or total ownership, or an investment management interest. Real estate investor 110 may be any individual or conglomerate investor, including, for example, asset managers or private equity firms, insurance companies, or real estate investment trusts. In some embodiments, real estate investor 110 may be a plurality of investors in a joint venture, who may designate one investor (such as a majority owner) to manage the property finances, as discussed in greater detail below. Where real estate investor 110 is a plurality of investors in a joint venture, the plurality of investors may also collectively agree on management of the property finances. In some embodiments, the properties 120 may be wholly owned by real estate investor 110. In an embodiment, the real estate management system 100 may be utilized for any number of investment properties, including both wholly owned properties and joint venture properties, for example. Properties 120 may be of any type, including residential (i.e. apartment buildings, condominiums, townhouse communities, or so on), commercial (i.e. retail or office space), or mixed usage. Real estate investor 110 may own any number of properties 120. Typically, real estate management system 100 will be implemented when real estate investor 110 owns numerous properties 120 that are managed by property managers 130. In the illustrated embodiment of real estate management system 100, real estate investor 110 owns four properties, properties 120a-d. As shown, property 120a and property 120b are managed by property manager 130a, while property 120c and property 120d are managed by property manager 130b. The number of property managers 130 may also vary. In an embodiment, a given property manager 130 might only manage a single property 120, while in another embodiment, a given property manager 130 might manage multiple properties 120.

As depicted in FIG. 1, real estate management system 100 may be configured such that treasury service provider 140 provides investor access portal 150 to real estate investor 110 via investor link 160. Property managers 130 may also be linked with investor access portal 150 via property manager links 170. Investor link 160 and property manager links 170 are discussed in greater detail below. Treasury service provider 140 may be any provider of treasury or other financial services, including, in some embodiments, the initiating or reporting of payment transactions. Initiating payment transactions may include presenting bills, providing for payments, check, wire transfer, or other payment management, or so on. Reporting may include, for example, notification of collections, disbursements, or payments. In an embodiment, treasury service provider may be an investment bank, such as the Bank of New York Mellon. Investor access portal 150, described in greater detail below, may be operated on any type of computerized or electronic medium, including but not limited to dedicated hardware, a personal computer, a mainframe computer, a rack mounted server, a server, a workstation, or so on. The computerized or electronic medium associated with investor access portal 150 may include one or more processors, and one or more memory devices, which may contain or link to one or more databases. In an embodiment, the computerized or electronic medium may utilize multi-processor configurations which, with proper programming, may be useful to improve processing speed.

The one or more memory devices may be, for example, known types of solid-state memory such as dynamic random access memory (DRAM) that stores information, including information formatted for storage in the one or more databases. The memory device(s) may be backed up by known redundant storage media, e.g., hard disk drives, solid state drives, optical media, tape media, or so on. In an embodiment, the one or more databases may include a structured database, which may be implemented, for example, as a Structured Query Language (SQL) database or other type of known database format that is compatible or desired to be used with the particular software programming approach used to implement financial data management for properties 120. A front end user interface for investor access portal 150, and a back end data management and analysis component for investor access portal 150 may utilize any appropriate programmatic language and/or markup language, including but not limited to Java, BASIC (or variants), C (or variants), XML, HTML, or combinations thereof.

Investor link 160 and property manager links 170 may connect real estate investor 110 and property managers 130 to treasury service provider 140 by any appropriate mechanism. For example, in some embodiments investor link 160 and property manager links 170 may utilize appropriate computer network interfaces using, for example, the Internet and TCP/IP communication protocols, or through a private network. Precautions necessary to ensure the privacy and security of electronic data exchanged between real estate investor 110, property managers 130, and treasury service provider 140 may be taken in any number of known ways, including for example, security protocols based on Transport Layer Security (TLS), Secure Sockets Layer (SSL), or other data encryption mechanisms, such as Pretty Good Privacy (PGP), for example. In an embodiment, investor access portal 150 may utilize a graphical user interface, such as a web browser interface, for receiving and displaying data transmitted over investor link 160 and/or property manager links 170. Such an interface may be implemented by any number of conventional input/output and/or display devices, including but not limited to a mouse, keyboard, touch screen, and so on.

Investor access portal 150 may be configured to provide real estate investor 110 the ability to direct or otherwise manage a variety of treasury service actions provided through or otherwise simplified by treasury service provider 140. Investor access portal 150 may also permit real estate investor 110 to view and/or analyze data received by treasury service provider 140 associated with properties 120. Such data is described in greater detail below. As shown in FIG. 1, an exemplary investor access portal 150 may provide access to accounts receivable (A/R) servicing 180, accounts payable (A/P) servicing 190, and accounting/performance reporting 200. Investor access portal 150 may also provide access to real estate specific services 210. Such real estate specific services 210 may vary in different embodiments, but may include, for example, energy procurement 220, document management 230, and lease abstracting 240. These components are described in greater detail below.

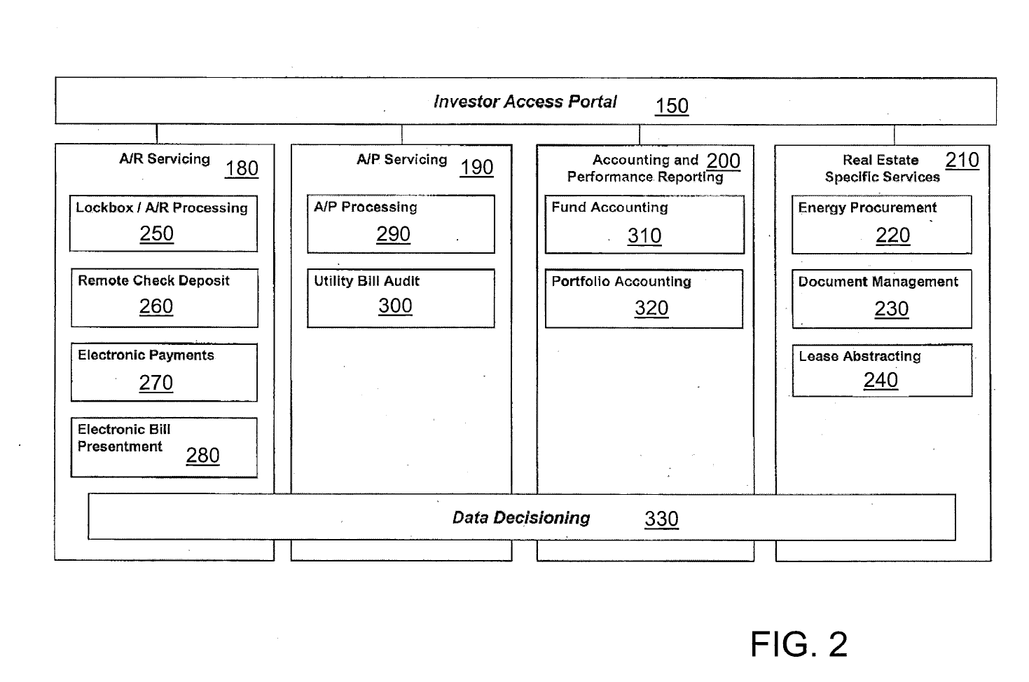

Turning to FIG. 2, examples of some services provided to real estate investor 110 via investor access portal 150 may be seen in greater detail. For example, as a component of A/R servicing 180, investor access portal 150 may provide lockbox services 250. Lockbox services 250 may be of any suitable type, including, for example, providing management of rent payments made by one or from across a plurality of properties 120. Lockbox services 250 may be configured to permit real estate investor 110 to have one or more centralized money collection points, which may permit access to real time A/R information. In an embodiment, funds may be received at the centralized collection point by any postal or parcel delivery service, or may be sent electronically, as described below. In an embodiment, once collected at the centralized collection points, collected financial instruments may be imaged for further transmission, i.e. to an even more centralized collection point, or to a designated one of the centralized collection points. Such further transmission may include transmission of an imaged instrument via the internet (i.e. Telecash), encrypted CD-ROM or other data storage media, to a standard processing location. In an embodiment, the A/R information may be extracted and keyed from the imaged instrument via intelligent character recognition or other character recognition mechanisms. In an embodiment, lockbox services 250 may store the A/R information in an auditable form, potentially within the one or more databases as scanned images, or other traceable format. In an embodiment, lockbox services 250 may be configured to receive both paper and electronic payments. In an embodiment where treasury service provider 140 is a bank, lockbox services 250 may permit accelerated processing of incoming cash, and reduction of exception items (i.e. deposits that are held over due to uncertainty that a deposit will clear).

Associated with lockbox services 250, A/R servicing 180 may additionally include remote check depositing 260. Remote check depositing 260 may include check scanning and deposit services that may be located with the property managers 130 (or at each of the properties 120), and connected to treasury service provider 140, so that the checks (i.e. rent payments) may be promptly received and deposited with treasury service provider 140. In an embodiment, remote check depositing 260 may be in compliance with the Check Clearing for the 21^{st} Century Act (the “Check 21 Act”), which permits the creation of a digital “substitute check” for an original paper check, to increase the speed of processing and reduce float. A/R servicing 180 may further include electronic payments management 270, which may enable electronic payment of rent through credit card, debit card, or Automated Clearing House (ACH) mechanisms. In an embodiment, electronic payments management 270 may be offered directly to renters of properties 120, eliminating the intermediary nature of property managers 130 for the financial aspects of managing properties 120. Again, the prompt movement of payments from the renters of properties 120 to real estate investor 110, via the centralized connections of a bank-based treasury service provider 140 may reduce float and other delays in receipt of the funds by real estate investor 110, and thus increase return on investment.

In an embodiment, A/R servicing 180 may further include electronic bill presentment 280, such that tenants of properties 120 may electronically receive bills for rent and expenses, which may be paid through electronic payments management 270. Electronic bill presentment 280 may include, for example, notifying tenants of properties 120 of bills utilizing e-mail, text messaging, or so on. In some embodiments, electronic bill presentment 280 may be configured such that real estate investor 110, property managers 130, and/or the tenants of properties 120 may view and track a history of bills associated with properties 120. In some embodiments, electronic payments management 270 and electronic bill presentment 280 may be configured to consolidate cash management balance reporting, including, for example, through reporting of receivables in formats compatible with or otherwise associated with bodies such as the Banking Administration Institute (BAD. In some embodiments, electronic payments 270 and electronic bill presentment 280 may be provided as white-label, and thus would be branded with the indicia or logos as being a product provided by either real estate investor 110 or property manager 130 when presented to the tenants of properties 120. In an embodiment, tenants may be provided with login or other identifying information for a web interface associated with electronic bill presentment 280, so that payments from the tenants to real estate investor 110 may be made using any electronic mechanism, including but not limited to electronic wire transfers, e-checks, ACH, payment card information, electronic drafts, and electronic foreign exchange transactions. In an embodiment, while the bill presentment may be electronic via electronic bill presentment 280, payment may be received via paper transfer, including but not limited to via the non-electronic equivalents of the electronic mechanisms described above. Removing or reducing the role of property managers 130 from the process of receiving payments tenants of properties 120, such as by centralizing payments via investor access portal 150, may further mitigate risks associated with such transactions that occur when payment instruments are moved through superfluous intermediaries.

In various embodiments, the funds received through A/R servicing 180 may alternatively be stored in consolidated or segregated accounts. Where consolidated, the accounts may be traceable, so that if the A/R funds are to be utilized as investment vehicles, future unraveling of accounts may be simplified when the investment vehicles mature. Consolidation may, in various embodiments, be based on funds associated with properties 120 in a particular geographic location, utilizing a particular property manager 130, associated with a particular type of property 120.

As noted above, investor access portal 150 may further provide A/P servicing 190. A/P servicing 190 may be configured to provide invoice processing and payment tools to standardize payments to suppliers. As shown in FIG. 2, A/P servicing 190 may include A/P processing 290, that may interface to the general ledger (G/L) associated with one, some, or all of properties 120. A/P processing 290 may, for example, convert supplier interfaces to e-commerce for invoicing and payments. In an embodiment, A/P processing 290 may include providing payment mechanisms via a number of mechanisms, including but not limited to wire transfers, checks, ACH, payment cards, drafts, and foreign exchange transactions. In an embodiment, A/P processing 290 may include one or more disbursement tools, that may provide notification of automatic payments, provide fraud prevention tools, and provide other record-keeping that may be utilized to improve A/P control and analytics. In some embodiments, record keeping provided by A/P processing 290 may include audit trails sufficient for inspections such as those performed under Sarbanes-Oxley or the Statement on Auditing Standards No. 70, Type II (SAS70 II).

In an embodiment, A/P servicing 190 may include tools to audit A/P expenditures. For example, as shown in the illustrated embodiment, A/P servicing 190 may include utility bill auditing 300. Utility bill auditing 300 may provide analysis of a history of utility or other service bills paid across properties 120. Such analysis may identify savings based on service provider selection, by establishing a greater data set across properties 120 managed by different property managers 130 (such as both properties 120a-b and properties 120c-d, as opposed to just properties 120a-b). In an embodiment, utility bill auditing 300 may provide sourcing analysis based on location data for properties 120. In an embodiment, utility bill auditing 300 may provide analysis based on financial and/or consumption variables including but not limited to bill payment history, utility cost history, utility usage history, cost as a factor of property size, cost as a factor of property age, or so on. In an embodiment, utility bill auditing 300 may provide benchmarking of utility bill payments, or detail opportunities for rate bargaining or other reductions. For example, analysis under utility bill auditing 300 across a plurality of properties 120 may be utilized to leverage or negotiate rates with one or more utility providers. Such utility providers may be of any type, including but not limited to electric companies, gas companies, water companies, maintenance companies, internet service providers, cable media providers, satellite media providers, telephone companies, insurance companies, or so on. In some embodiments, utility bill auditing 300 may provide analysis of property managers 130.

In an embodiment, utility bill auditing 300 may be associated with energy procurement 220, which may facilitate procuring utilities (in particular from lower-cost utility providers) based on the results uncovered during an audit. In an embodiment, energy procurement 220 may be tailored to provide comparative analysis to procure energy sources from deregulated markets. In some embodiments, utility bill auditing 300 may also provide error detection and resolution services, to identify overpayments and statistical outliers, based on the size and configurations of properties 120, based on the utility costs to operate properties 120. In an embodiment, A/P servicing 190 may facilitate providing utility bill audit reports to property managers 130 and real estate investor 110, providing appropriate comparison data and future forecasts, analyzing properties 120 based on comparison to other properties 120, comparison to past utility bills, or so on. In an embodiment, such reporting may provide analysis of year-to-date performance as compared to past annual performance, or estimated current or future year performance.

Accounting/performance reporting 200 that may be provided via investor access portal 150 may be configured to cooperate with A/R servicing 180 and A/P servicing 190, so as to provide accounting for properties 120 across property managers 130. In an embodiment, accounting/performance reporting 200 may include fund accounting 310, which may provide accounting based on particular funds wholly owned or jointly run by real estate investor 110. For example, where real estate investor 110 has separated properties 120 based on the source of financing for those properties 120, fund accounting 310 may be configured to provide valuation and reporting of other account metrics to enhance profitability analysis, and regulatory compliance, of the funding of all or some of properties 120. In some embodiments, fund accounting 310 may include calculation and/or reporting of return on equity, return on investment, and/or other metrics configured to measure returns to market benchmarks. In an embodiment, accounting/performance reporting 200 may comprise portfolio accounting 320, which may be configured to provide valuation and reporting of other account metrics based on properties 120, including, for example, analysis of real estate valuation, depreciation, maintenance fees, expenditures, tax management, and so on. The performance of the funds or the portfolios associated with properties 120 may be reported in any appropriate way, including but not limited to comparative tables, charts, graphs, statistics, tickers, histograms, or so on.

As indicated previously, further real estate specific services 210 may also be provided over investor access portal 150. Besides energy procurement 220, discussed above, investor access portal 150 may provide document management 230, which may store and give access to digital copies of real estate documentation such as the deed, the title, and lease agreements pertaining to properties 120. In an embodiment, document management 230 may selectively provide access to some or all of the real estate documentation to real estate investor 110, property managers 130, the tenants of properties 120, or other associated third parties. Associated with document management 230 may be lease abstracting 240, wherein elements of the lease may be isolated and separated for easy searching and comparison of lease terms across properties 120, the tenants of properties 120, and property managers 130.

In various embodiments, the services described herein may be provided over investor access portal 150 as individually selectable, or as bundles of services. For example, in an embodiment where each service is individually selectable, real estate investor 110 may elect to utilize document management 230, but may elect to not utilize lease abstracting 240. In an embodiment where services are bundled, real estate investor may elect to utilize A/R servicing 180, but may elect to not utilize A/P servicing 190. In some embodiments, the bundled services may cross the service categories described herein. As an example, an energy bundle may exist that provides A/P processing 290 and utility bill audit 300 from A/P servicing 190, as well as energy procurement 220 from real estate services 210. In some embodiments, non-selected services may be obscured from investor access portal 150, such that real estate investor 110, or property managers 130, only view only those services that they have access to.

As indicated in FIG. 2, aspects of A/R servicing 180, A/P servicing 190, accounting/performance reporting 200, and real estate services 210 may include facilitating data decisioning 330. The services provided over investor access portal 150 may be configured such that real estate investor 110 may utilize the information gathered regarding a plurality of properties 120, managed by a plurality of property managers 130, to make financial determinations regarding the application of the services to one or more properties 120. Consolidation of data decisioning 330 via investor access portal 150 may provide a number of benefits, including but not limited to facilitating cost-cutting analysis across multiple properties 120. While conventional systems may permit such cost-cutting analysis for a single property 120 (i.e. property 120a), or for a plurality of properties 120 managed by a single property manager 130 (i.e. properties 120a-b, managed by property manager 130a), such systems lack capability to combine and extrapolate such analysis across multiple property managers 130 (i.e. property managers 130a-b), each of which may conventionally utilize data capture and reporting systems that are incompatible with one another. In some embodiments, data decisioning 330 may include identifying and facilitating potential savings based on money market or other cash investment strategies. In some embodiments, the investment strategies may include short term investments, which may be as short as overnight, and utilize consolidated funds received via lockbox services 250.

Benefits of providing consolidated services by investor access portal 150 include allowing real estate investors 110 to increase operating efficiencies, reducing costs while providing a holistic financial view of portfolios of properties 120. For example, as indicated above, A/R servicing 180 and A/P servicing 190 may be configured to provide A/R and A/P processing at the fund or portfolio level, which may cut costs while standardizing metrics capture and reporting. In an embodiment, investor access portal 150 may provide integrated reporting and analytics for properties 120, which may be utilized to identify cost savings such as, for example, identifying or otherwise providing comparative data to allow identification of lower-cost energy providers, or property management practices that may result in lower operating costs. In an embodiment, such data may be utilized to identify the potential for Energy Star, Leadership in Energy and Environmental Design (LEED), or other energy certification programs, which may be advantageous for cost-savings (including utility costs, as well as potential tax benefits), marketing to potential tenants or joint investors, increase property values (and potential rental income), reduce points in the mortgage of properties 120, and demonstrate that real estate investor 110 engages in socially responsible business practices.

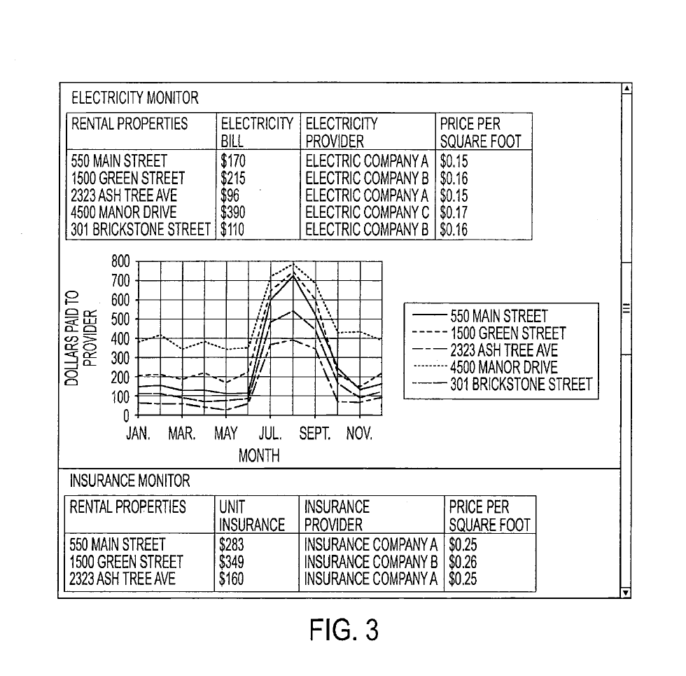

As noted above, in some embodiments investor access portal 150 may comprise a graphical user interface provided over a computer terminal. FIGS. 3-5 depict various aspects of an embodiment of the graphical user interface of investor access portal 150. These screens are not necessarily intended to convey precise information or formats of information available through investor access portal 150, but are merely representative of the types of displays and information presented therein that may be made available to system users. In an embodiment where the graphical user interface is presented over the internet, the graphical user interface may be generated by any suitable mechanism, including but not limited to via hypertext markup language, extended markup language, Microsoft® SharePoint®, Adobe® Flash®, and combinations thereof.

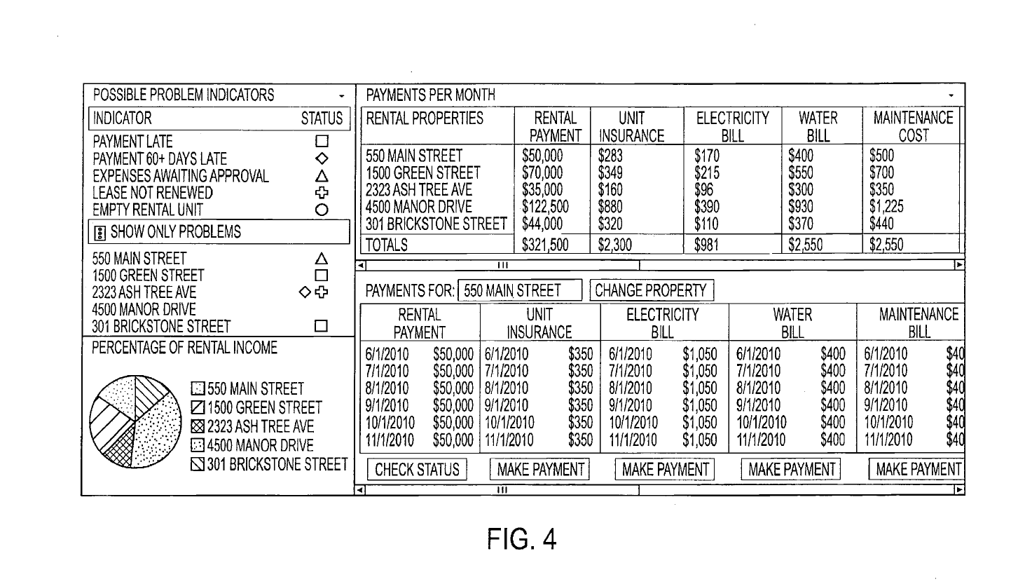

As shown in FIG. 3, in an embodiment financial data about properties 120 may be presented to real estate investor 110 both as text and graphically. In the illustrated embodiment, payables data may be depicted by service/utility type, and may provide historical data across providers. In an embodiment, the payables data may be subdivided by property utilizing said service/utility provider. In an embodiment, filters may be applied to prioritize sorting, such that similar properties 120 (i.e. in terms of size, age, or location) are grouped together, such that comparisons between properties 120 may be performed by real estate investor 110. In some embodiments, such analytics may be performed by treasury service provider 140, and presented to real estate investor 110 via investor access portal 150. In an embodiment, such comparisons may be depicted graphically, showing contributions of each service/utility provider to the overall A/P analysis. In some embodiments, the interactivity of investor access portal 150 may provide for pop-ups or linking information screens, such as those depicted in FIG. 4, which in some embodiments may be responsive to user input on the textual designations or graphical depictions of FIG. 3. For example, clicking on certain headers or status indicators may pop-up definitions or help regarding those headers or status indicators. As another example, clicking on some of the graphically represented A/P or A/R data may pop-up additional analytics regarding the A/P or A/R data, such as breaking down a holistic financial snapshot from data across a plurality of property managers 130 such that data from each property manager 130 may be appreciated.

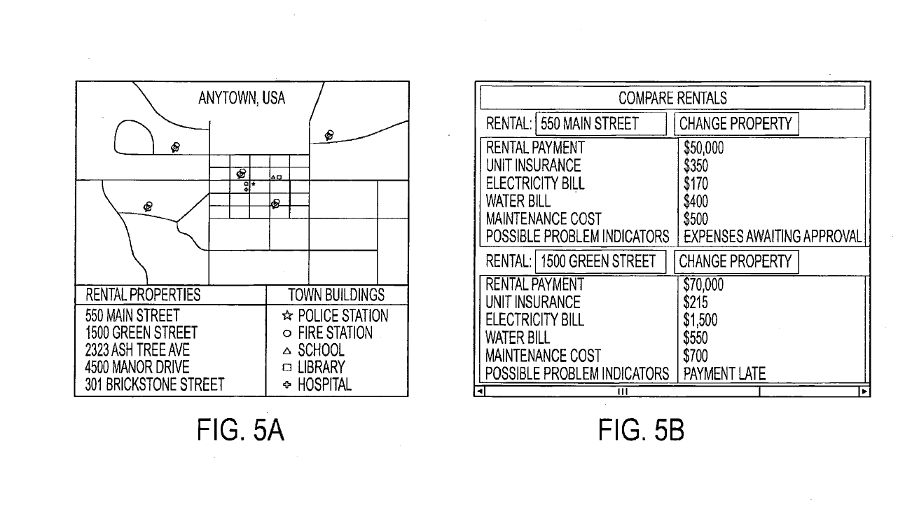

As is shown in FIG. 5A and FIG. 5B, other interfaces to depict and represent may alternatively or additionally be presented over investor access portal 150. For example, in the views of FIGS. 5A-B, the data may be presented to show contributions according to geographic location. In the view of FIG. 5A, for example, each property 120 may be graphically represented on a map. Such a map may have a plurality of selectable overlays, including for example, demarcating service boundaries of various service/utility companies, locality boundaries (i.e. for taxation distinctions), or so on. In an embodiment, by hovering over a given property 120, certain information about the given property 120 may be provided in a floating overlay on the map. By clicking on a property 120, investor access portal 150 may change to the view of FIG. 5B, wherein data specific to the selected property 120 is presented. As shown, in some embodiments the data specific to a selected property 120 may be compared to surrounding, similar, or otherwise associated properties 120. In an embodiment, the user interface depicted in FIG. 5A may be configured such that multiple properties 120 may be selected. In an embodiment, such selection may be achieved by click/hold and dragging the cursor across a plurality of properties 120. In another embodiment, a plurality of properties 120 may be individually clicked to indicate selection, before a separate “compare” button is clicked to bring the user to a comparative views similar to that of FIG. 3, FIG. 4, or FIG. 5B.

Various embodiments herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What we claim is:

1. A computer-implemented method of managing, evaluating and reporting financial information for real estate investment portfolios, the method comprising:
storing, in a database associated with a memory device, first property information associated with at least one or more first properties managed by a first property manager, and second property information associated with at least one or more second properties managed by a second property manager;
using a processor to compare the first property information and the second property information; and
outputting for use by a real estate investor having a financial investment in each of the first and second properties, one or more of the first property information, the second property information, and the comparison of the first property information and the second property information.

2. The method of claim 1, wherein the first property information comprises first accounts payable information, and the second property information comprises second accounts payable information.

3. The method of claim 2, wherein said first accounts payable information and said second accounts payable information include bills associated respectively with the one or more first properties or the one or more second properties.

4. The method of claim 3, further comprising performing an audit of said bills to identify potential expenditure savings.

5. The method of claim 4, wherein said bills are energy bills from one or more energy providers, further comprising identifying lower-cost energy providers for the one or more first properties or the one or more second properties, based on results of said audit.

6. The method of claim 3, wherein said bills comprise one or more of utility bills, mortgage bills, tax bills, and maintenance bills.

7. The method of claim 3, further comprising enabling said real estate investor to pay said bills via at least one user interface.

8. The method of claim 1, wherein the first property information comprises first accounts receivable information, and the second property information comprises second accounts receivable information.

9. The method of claim 1, further comprising providing a centralized location to receive funds associated with one or more of the first properties and one or more of the second properties.

10. The method of claim 9, wherein said funds are funds received from said real estate investor to pay bills associated with said first property and/or said second property.

11. The method of claim 9, wherein said funds are funds received from one or more tenants of said first property and/or said second property, payable to said real estate investor.

12. The method of claim 11, wherein said centralized location comprises a one or more of a lockbox, a remote check depositing service, or an electronic payment service.

13. The method of claim 11, further comprising electronically presenting bills to said one or more tenants.

14. The method of claim 1, further comprising providing accounting and performance reporting associated with at least the one or more first properties and/or the one or more second properties.

15. The method of claim 14, wherein said accounting comprises fund accounting based on an investment fund associated with the one or more first properties and/or the one or more second properties.

16. The method of claim 14, wherein said accounting comprises portfolio accounting based on the one or more first properties and/or the one or more second properties.

17. The method of claim 1, further comprising providing storage for copies of documents associated with at least the one or more first properties and/or the one or more second properties.

18. The method of claim 17, wherein said documents comprise deeds, titles, or lease agreements.

19. The method of claim 1, further comprising extracting and cataloging lease information associated with one or more leases associated with the one or more first properties and/or the one or more second properties.

20. The method of claim 1, wherein the first property information and the second property information each comprise one or more of valuation, fiscal information, location information, property size, tax information, mortgage payments, utility expenses, tenant information, and rental income.

21. The method of claim 1, wherein said outputting is configured for display over at least one user interface.

22. A system for computerized management, evaluation, and reporting of financial information for real estate investment portfolios, the system comprising:
a management platform comprising an operatively interconnected processor and a memory device;
a database associated with the memory device and configured to store property information received over a network connection, said property information including first property information associated with at least one or more first properties managed by a first property manager, and second property information associated with at least one or more second properties managed by a second property manager;
wherein the processor is configured to:
compare the first property information and the second property information; and
output, for use by a real estate investor having a financial investment in each of the first and second properties, one or more of the first property information, the second property information, and the comparison of the first property information and the second property information.

23. The system of claim 22, wherein the first property information comprises first accounts payable information, and the second property information comprises second accounts payable information.

24. The system of claim 23, wherein said first accounts payable information and said second accounts payable information include bills associated respectively with the one or more first properties or the one or more second properties.

25. The system of claim 24, wherein the processor is further configured to perform an audit of said bills to identify potential expenditure savings.

26. The system of claim 25, wherein said bills are energy bills from one or more energy providers, wherein the processor is further configured to identify lower-cost energy providers for the one or more first properties or the one or more second properties, based on results of said audit.

27. The system of claim 24, wherein said bills comprise one or more of utility bills, mortgage bills, tax bills, and maintenance bills.

28. The system of claim 24, wherein the processor is further configured to enable said real estate investor to pay said bills via at least one user interface.

29. The system of claim 22, wherein the first property information comprises first accounts receivable information, and the second property information comprises second accounts receivable information.

30. The system of claim 22, wherein the management platform is operatively coupled to a centralized location configured to receive funds associated with one or more of the first properties and one or more of the second properties.

31. The system of claim 30, wherein said funds are funds received from said real estate investor to pay bills associated with said first property and/or said second property.

32. The system of claim 30, wherein said funds are funds received from one or more tenants of said first property and/or said second property, payable to said real estate investor.

33. The system of claim 32, wherein said centralized location comprises one or more of a lockbox, a remote check depositing service, or an electronic payment service.

34. The system of claim 32, wherein said processor is further configured to electronically present bills to said one or more tenants.

35. The system of claim 22, wherein said processor is further configured to provide accounting and performance reporting associated with at least the one or more first properties and/or the one or more second properties.

36. The system of claim 35, wherein said accounting comprises fund accounting based on an investment fund associated with the one or more first properties and/or the one or more second properties.

37. The system of claim 35, wherein said accounting comprises portfolio accounting based on the one or more first properties and/or the one or more second properties.

38. The system of claim 22, wherein said database is further configured to provide storage for copies of documents associated with at least the one or more first properties and/or the one or more second properties.

39. The system of claim 38, wherein said documents comprise deeds, titles, or lease agreements.

40. The system of claim 22, wherein said database is further configured to extract and catalog lease information associated with one or more leases associated with the one or more first properties and/or the one or more second properties.

41. The system of claim 22, wherein the first property information and the second property information each comprise one or more of valuation, fiscal information, location information, property size, tax information, mortgage payments, utility expenses, tenant information, and rental income.

42. The system of claim 22, wherein said output is configured for display over at least one user interface.

43. An article of manufacture comprising a tangible, non-transitory computer-readable medium therein, said computer-readable medium containing computer-readable instructions thereon which, when executed by a computer processor, cause the processor to carry out functions related to managing, evaluating and reporting financial information for real estate investment portfolios, the functions comprising:
storing, in a database associated with a memory device, first property information associated with at least one or more first properties managed by a first property manager, and second property information associated with at least one or more second properties managed by a second property manager;
comparing the first property information and the second property information; and
outputting for use by a real estate investor having a financial investment in each of the first and second properties, one or more of the first property information, the second property information, and the comparison of the first property information and the second property information.

44. A system for computerized management, evaluation, and reporting of financial information for real estate investment portfolios, the system comprising:
a management platform comprising an operatively interconnected processor and a memory device;
a database associated with the memory device and configured to store property information received over a network connection, said property information including first property information associated with at least one or more first properties managed by a first property manager, and second property information associated with at least one or more second properties managed by a second property manager, said first property information comprising first accounts payable or receivable information, and said second property information comprising second accounts payable or receivable information, the first and second accounts payable or receivable information including bills associated respectively with the one or more first properties or the one or more second properties, said database further configured to provide storage for and categorize copies of one or more of deeds, titles, and lease agreements associated with at least the one or more first properties and/or the one or more second properties;
wherein the processor is configured to:
compare the first property information and the second property information;
perform an audit of said bills to identify potential expenditure savings;
electronically present bills to the one or more tenants;
receive an input from a real estate investor and/or the one or more tenants to pay said bills via at least one user interface;
provide accounting based on a portfolio including the one or more properties and an investment fund associated with the one or more properties; and
output for use by the real estate investor one or more of the first property information, the second property information, the comparison of the first and second property information, a result of said audit, and a result of said accounting;
wherein the management platform is operatively coupled to a centralized location comprising one or more of a lockbox, a remote check depositing service, or an electronic payment service, the centralized location configured to receive funds from one or more of the real estate investor and tenants of the first property and/or the second property, associated with one or more of the first properties and one or more of the second properties;
wherein the first property information and the second property information each comprise one or more of valuation, fiscal information, location information, property size, tax information, mortgage payments, utility expenses, tenant information, and rental income; and
wherein the real estate investor has a financial investment in each of the first and second properties.
